(19) United States
(12) Patent Application Publication
(10) Pub. No.: US 2007/0081577 A1
(43) Pub. Date: Apr. 12, 2007

(54) Pulse-based communication

(76) Inventors: Jukka Reunamaki, Tampere (FI); Arto Palin, Viiala (FI)

Correspondence Address: HARRINGTON & SMITH, PC, 4 RESEARCH DRIVE, SHELTON, CT, 06484-6212, US

(21) Appl. No.: 10/578,695

(22) PCT Filed: Nov. 12, 2004
(86) PCT No.: PCT/FI04/00674

§ 371 Date: May 9, 2006

(30) Foreign Application Priority Data
Nov. 17, 2003 (FI) 20031665

(51) Int. Cl. H04B 1/00

(52) U.S. Cl. 375/130

(57) ABSTRACT

The invention relates to a method for broadband communication. The method includes transmitting a sequence of pulses or impulses at a pulse repetition frequency from a first communication device to another device via a wireless link. The method further includes adjusting the pulse repetition frequency based on channel delay spread measurements performed by said another device.

### FIELD OF THE INVENTION

The invention relates to wideband pulse-based communications. Especially, the invention relates to ultra-wideband (UWB) communications.

### BACKGROUND OF THE INVENTION

Ultra-wideband (UWB) communication technology has been known for decades. Actually, in 1887, German physicist Heinrich Hertz, discovered radio waves by using a spark gap transmitter, which can been considered as an early UWB radio. That is, the first radio transmission ever made employed UWB technology. Later the use of UWB radios was banned because they use a relatively wide spectrum and therefore UWB technology was not used in commercial communication applications for a long time. However, in late 1990's, the use of UWB technology was brought up again and in 2002 FCC (Federal Communications Commission) permitted the marketing and operation of UWB devices in the USA, which enables public use of UWB communications. It is likely that public use of UWB communications will be allowed also in other parts of the world.

The FCC regulations permit the usage of UWB transmission for communication purposes in the frequency band of 3.1-10.6 GHz. With current ruling the transmitted spectral density has to be under −41.3 dBm/MHz and the utilized bandwidth has to be higher than 500 MHz.

In general, UWB devices operate by employing very narrow or short duration pulses that result in very large or wideband transmission bandwidths. That is, information is sent over the air by using pulses instead of continuous wave, the method which is used in most of the conventional radios. The frequency, in which the pulses are repeated (Pulse Repetition Frequency, PRF), can be selected to be lower than the channel coherence time (1/delay spread of the channel) of the respective communication link so that there is no need for equalization in the receiver. Therefore, there is a certain guard time (or interval) between adjacent pulses. Because the spectrum used for UWB communications is in GHz range, the used pulses have to be very short in order to fulfill the spectrum requirements. Depending on utilized technology, the pulse lengths are typically around a couple of pico- or nanoseconds, while the guard time between the pulses may be in the scale of tens or hundreds of nanoseconds.

So-called Impulse Radio (IR) concept is one of the technologies that fulfill the requirements set to UWB technologies. When using IR, the data is transmitted by using short baseband pulses, that is, there is no carrier modulation included in the transmission. Also so-called RF (Radio Frequency) gating type of impulse radio can be used in UWB communications. Therein the actual pulse is a gated RF pulse, which is a sine wave masked in time domain with a certain pulse shape.

A basic IR transmitter is relatively simple. In its simple form the IR transmitter comprises basically only a pulse generator and an antenna. Because transmission power in an IR radio is low, there is no need for a power amplifier, and because signaling is baseband signaling, there is no need for a mixer or for a voltage controlled oscillator (VCO). An IR receiver is more complex than the IR transmitter. Nevertheless, an IR receiver is simpler than a conventional continuous wave receiver, at least in principle, since in an IR receiver, there is no need to use intermediate frequencies, which simplifies the receiver.

UWB communications are typically short range, high speed, peer-to-peer communications, that is, communications between two end-user devices. In present UWB communication applications, a physical communication channel is shared between uplink (data transmitted from a first end-user device to a second end-user device) and downlink (data transmitted from the second end-user device to the first end-user device) in a time division type of manner. That is, the physical communication channel is divided into time slots in time domain and some of the time slots are allocated to the downlnk and some of the time slots are allocated to the uplink. Link control information, such as acknowledgement messages, which is needed for maintaining the communication link between the communicating parties, is sent on the same physical channel with the actual data. A general presentation on a particular UWB system is presented in the international patent application publication WO 01/39451 A1.

Since UWB communications are still in the development phase, all implementation details of UWB communications have not been agreed on yet, and many still require further consideration. One matter to discuss is the support for different air interface data rates or data rate modes.

Conventionally, a plurality of PRFs has been defined so as to support different data rates. Accordingly, current proposals in the field suggest the PRF to be fixed so that there exists a set of PRF values which can be selected for use in order to adjust the data rate. However, the problem with current proposals is that they do not appear to present an optimal way to adjust the PRF and the data rate. The requirements are controversial: On one hand, one should avoid inter-symbol interference between two (or more) adjacent symbols or bits, which occurs due to delay spread on the used communication channel. Therefore, the used PRF should be low enough to support a maximum distance between a transmitting and a receiving device. However, on the other hand, the used PRF should be high enough to meet the ever increasing demand of higher data rates.

### SUMMARY OF THE INVENTION

The present invention provides a solution for adjusting pulse-based transmission to meet transmission channel conditions.

According to a first aspect of the invention, there is provided a method for wide-band communication, the method comprising:

transmitting pulses from a first communication device to another device via a wireless link at a pulse repetition frequency, the pulse repetition frequency substantially defining a time difference between adjacent pulses, the method comprising:

performing measurements, based on pulses received at said another device, in order to obtain information on delay conditions of the wireless link; and adjusting the pulse repetition frequency based on said measurements.

In an embodiment of the invention, a set or a sequence of pulses is transmitted at a pulse repetition frequency (PRF) in accordance with ultra-wideband (UWB) technology. The pulses may be impulses or narrow pulses having a certain shape.

In an embodiment, said measurements comprise channel delay spread measurements which are performed in order to establish information on delay spread conditions of a transmission channel currently in use or to be used. In an embodiment, the PRF of an UWB wireless link between said first communication device and said another device (which may be another communication device) is adjusted based on said measurements. An air-interface data rate is proportional to the PRF. Embodiments of the invention thus provide tools for adaptively adjusting data rate in accordance with link quality (channel conditions). Data rate can be increased in good link conditions and the channel capacity can be optimized.

According to a second aspect of the invention, there is provided a communication device configured for wideband communication, the communication device comprising:

a receiver for receiving pulses transmitted, by another device, via a wireless link, wherein the communication device comprises:

a measurement arrangement for measuring, based on the received pulses, delay conditions of the wireless link for link adjustment purpose.

According to a third aspect of the invention, there is provided a communication device configured for wideband communication, the communication device comprising:

a transmitter for transmitting pulses via a wireless link to another device; and

a receiver for receiving link control information from said another device, wherein the link control information comprises information indicative of measured delay conditions of the wireless link for link adjustment purpose.

The communication device(s) according to embodiments of the invention may be any suitable electronic device(s), such as a mobile phone, a laptop computer, a desktop computer, a Personal Digital Assistant (PDA) or a digital camera. The communication devices may comprise an impulse radio (IR) for communication.

According to a fourth aspect of the invention, there is provided a system according to claim 13.

Dependent claims contain some embodiments of the invention. The subject matter contained in dependent claims relating to a particular aspect of the invention is also applicable to other aspects of the invention.

### BRIEF DESCRIPTION OF THE DRAWINGS

Embodiments of the invention will now be described by way of example with reference to the accompanying drawings in which:

FIG. 1 shows an ultra-wideband (UWB) communications system;

FIG. 2 shows a UWB communication part of a device;

FIG. 3 illustrates the concept of delay spread in detail;

FIG. 4 shows a measurement arrangement according to an embodiment of the invention; and

FIG. 5 shows a protocol stack structure according to an embodiment of the invention.

### DETAILED DESCRIPTION

Embodiments of the invention will be described in connection with ultra-wideband (UWB) communications. A person in the art will understand that the invention is not restricted to the details of the specific examples presented. The term UWB communications herein refers in general to a communication technology, wherein data is transmitted by means of narrow or short duration pulses or impulses (a special case of a pulse), and wherein transmitted pulses or impulses are spaced apart in the time domain by a certain guard time which is, typically, much longer than the duration of the transmitted pulse (or impulse). The transmitted pulses may be baseband pulses.

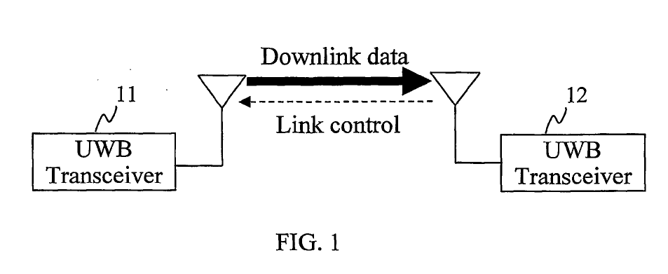

FIG. 1 shows a UWB communications system. The system comprises a first UWB device 11 and a second UWB device 12. The UWB. devices 11 and 12 both comprise a UWB communications part with the aid of which a UWB communication link between the UWB devices 11, 12 is established. The first UWB device 11 transmits downlink data to the second UWB device 12 and the second UWB device 12 sends link control information in uplink using the same or different frequency band that is used for downlink data transmission.

It should be noted that herein the terms uplink and downlink are used simply for referring to opposite directions of data transmission, therefore they can be used interchangeably.

In practice the first UWB device 11 may be, for example, a digital camera or a mobile phone, while the second UWB device 12 may be, for example, a desktop or laptop computer.

Data that is transmitted in dowlink may be, for example, data files, such as digital photographs, to be stored or processed in the desktop or laptop computer.

The link control information may be transmitted, for example, on the same communication channel as downlink data, or by using a separate radio. In an embodiment of the invention, the link control information comprises measurement-based information on delay spread conditions experienced by the second UWB device 12. Based on this information, used transmission pulse repetition frequency (PRF) is appropriately adjusted in order to optimize the air interface data rate (which is proportional to the PRF) between the UWB transceivers 11 and 12. Details of this embodiment are more closely discussed later in this description.

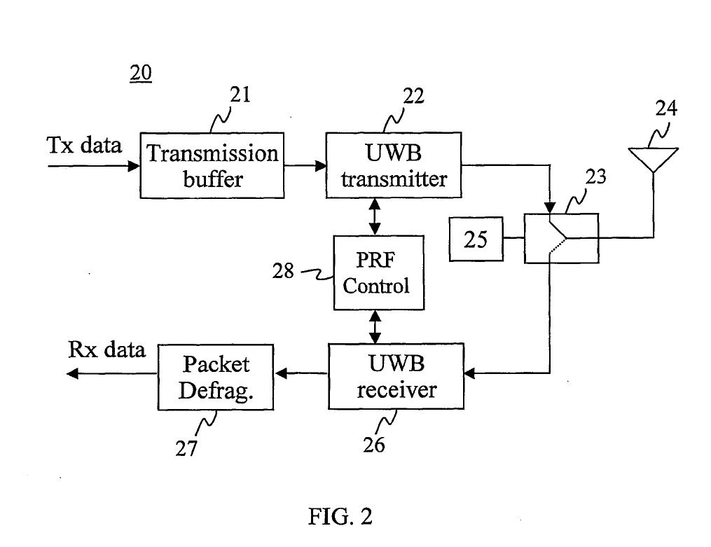

FIG. 2 is a block diagram illustrating a UWB communication part 20 of a UWB device, such as the UWB device 11 or 12. In practice, the communication part 20 may be, for example, an integral part of a UWB device or an independent module operating in co-operation with other modules of a module assembly. The UWB communication part 20 comprises a transmission buffer block 21, which buffers data to be transmitted. The transmission buffer block 21 is coupled to a UWB transmitter block 22, which generates the pulses to be transmitted and which is further coupled to an antenna 24 via a switch 23. The switch 23 couples also a UWB receiver block 26 to the antenna 24. A switch control block 25, which controls switching between the UWB transmitter block 22 and the UWB receiver block 26, is coupled to the switch 23. The UWB receiver block 26 is further coupled to a packet defragmentation block 27 which outputs received data out of the communication part 20.

In an embodiment of the invention the first UWB device 11 (FIG. 1) transmits data to the second UWB device 12 (FIG. 2) and receives link control information from the second UWB device 12. With reference to FIG. 2, the data (Tx data) to be transmitted is conveyed in the UWB communication part 20 of the first UWB device 11 via the transmission buffer block 21 and the UWB transmitter block 22 to the switch 23 and further to the antenna 24 for over-the-air transmission to the second UWB device 12. When link control information transmitted by the UWB communication part 20 of the second UWB device 12 is received at the first UWB device 11, it is conveyed from the antenna 24 via the switch 23 and the UWB receiver block 26 to the packet defragmentation block 27 for packet defragmentation. Therefrom the received link control information (or data, Rx data) is conveyed for further processing. The switch control block 25 controls the switch 23 to switch between transmission and reception modes.

In an embodiment, the link control information received at the first UWB device 11 comprises measurement-based information on delay spread conditions experienced by the second UWB device 12. In this embodiment, that information is taken to a PRF control block 28 of the first UWB device 11. The PRF control block 28 is configured to control the operation of the UWB transmitter block 22 so as to adjust the used PRF in accordance with current delay spread conditions of the used transmission channel. In this way, air-interface data rate which is proportional to the used PRF can be increased and maximized in good channel conditions. Depending on the implementation, the PRF control block 28 can, alternatively, be implemented as a part of the UWB transmission block 22. In a UWB device which receives data the PRF control block 28 may also be used to control the timing of the UWB receiver block 26.

In a practical embodiment, the UWB devices 11 and 12 may use a fixed PRF in link set-up. This PRF should be selected so that a wireless link can be established between devices 11 and 12 for long echo conditions (long delay spread), i.e. the initial PRF should selected to be low enough. After link establishment, the PRF can be increased, if needed, and if channel conditions are suitable. The selection of a new PRF to be used is performed based on delay spread measurements carried out on the used transmission channel. The delay spread measurements are performed by one or more UWB devices (here: UWB device 12) which receive the pulses transmitted by the first UWB device 11. The new PRF, which is proportional to the measured delay spread, may be negotiated between the UWB devices over a link. The negotiation may be started by the first or second UWB device 11, 12, if there is a change (e.g. an increase) observed in the delay spread, or if otherwise decided. The negotiation may be accomplished, for example, by transmitting an increase/decrease type of request from the second (receiving) UWB device 12 to the first (transmitting) UWB device 11. Alternatively, a more sophisticated procedure in which an actual PRF is proposed may be carried out. If the transmitting device (here: the first UWB device 11) does not support the proposed PRF, it can use the closest possible PRF. However, since the PRF used for transmission at the transmitting device should be the same as the PRF used at the receiving device, the receiving device should be provided information about the PRF to be used. In some embodiments, it is always the receiving device that decides which PRF values can be accepted.

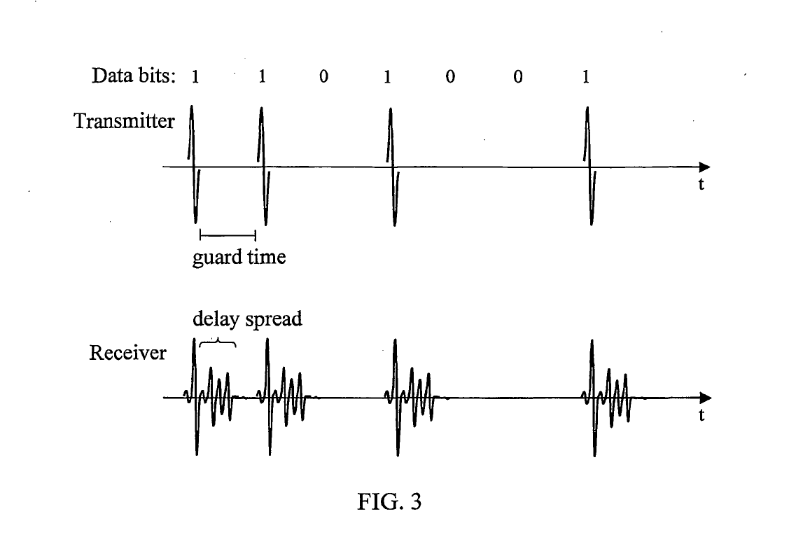

FIG. 3 shows the concept of delay spread in more detail. The Figure shows in time domain data pulses sent from a transmitter and the form in which the pulses are received at a receiver. More closely, FIG. 3 illustrates the shape of a bit sequence “1101001” at the transmitter and corresponding received energy at the receiver. It should be noted that FIG. 3 presents an imaginary case. Herein, the bit one (“1”) is transmitted by transmitting a pulse, and the bit zero (“0”) is transmitted by transmitting nothing. Also an opposite implementation is possible, that is, a pulse can be sent for every zero. Furthermore, any other method, in which a data bit is presented by means of a simple baseband pulse shape, can be used. For example, a zero may be presented by an inverted pulse. The timing and shape of transmitted pulses is negotiated beforehand between the transmitter and the receiver, so that the receiver “knows” when to listen to sent pulses and what shape they should take. On the basis of the energy received the receiver concludes whether a one or a zero was received.

The time between transmitted pulses is called the guard time and the spreading of the received pulse (or signal) in time domain at the receiver is called the delay spread. The delay spread is, typically, caused by multipath propagation of the transmitted signal.

If the PRF is increased the guard time. decreases. If the PRF is selected too high, the whole guard time is consumed by the delay spread of the received pulse. In that case, the delay spread may disturb the reception of the next pulse. In order to obtain information so that the PRF (and the air-interface data rate which is proportional to the PRF) may be optimized in respect of the delay conditions of the used channel, the delay conditions may be measured.

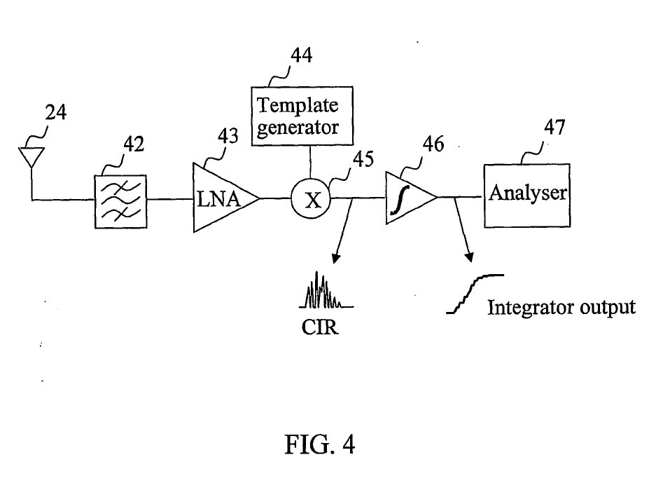

FIG. 4 shows an embodiment of the invention wherein a measurement arrangement is implemented in a receiving UWB device, e.g. the second UWB device 12 of FIG. 1. It should be noted that FIG. 4 is simplified to some extent. Only one possible measurement arrangement is shown.

The transmitted pulse and its multipath components are received by the antenna 24. From the antenna 24 the received signal is conveyed to a bandpass filter 42 which filters frequencies residing outside the used frequency band. The level of the received signal is amplified in a low noise amplifier 43. The amplified signal is conveyer to a correlator (or mixer) 45 in which it is mixed with a signal produced by a template generator 44. The signal produced by the template generator 44 has the expected shape of the received signal.

The output of the correlator 45 gives a channel impulse response (CIR). This is conveyed to an integrator 46 the output of which gives the sum of the channel impulse response. The output of the integrator 46 is analyzed by an analyzing unit 47. When the sum of the channel impulse response begins to flatten out, the edge of the channel impulse response has been found. This information (possibly added with a safety marginal) may be reported to the transmitting UWB device (here: the first UWB device 11 of FIG. 1) for a PRF negotiation or adjustment purpose. The transmitting UWB device then takes appropriate action.

If, for example, the PRF is too high the channel impulse response between two adjacent pulses will overlap. This can be seen in the integrator output as a (cumullative) sum which does not completely flatten out before the next received pulse makes it grow again. In this case, a decrease in the PRF can be negotiated.

The measurement of the CIR (or delay spread characteristics) can be performed with the same radio that is used for UWB communication, since it should be capable of measuring multipath components.

As described in the foregoing, in practice, PRF control (or negotiation) can be performed in the way that, based on delay spread measurements, the receiving UWB device requests the transmitting UWB device to increase or decrease the PRF. This request can be implemented by a separate link manager level message or as a part of link control information. The transmitting UWB device acknowledges the request and switches to the next closest PRF which is, depending on the request, higher or lower than the original PRF and supported by the UWB devices. The receiving device is provided with information about the “new” PRF to be used in said acknowledgement or in any other suitable way.

In a more sophisticated case the “closest available” PRF is negotiated. This embodiment may be implemented such that information on supported PRFs is changed in advance between devices during link initialization (or setup) phase. Also, during the link initialization, delay spread measurements concerning the channel to be used are performed. When a need for PRF adjustment arises, the receiver sends a separate link control level message (contents of this message can alternatively be combined with link control information transmission) where a new (supported) PRF is proposed. If the proposed PRF is acceptable to the transmitting UWB device, it acknowledges the proposal and, after acknowledgement, switches to said new PRF mode. If the proposed PRF is not acceptable to the transmitting UWB device, it may propose an alternative PRF value to the receiving UWB device. If, in turn, the proposed alternative PRF value is acceptable to the receiving UWB device, it sends an acknowledgement to the transmitting UWB device, and the use of said alternative PRF is started. If with this kind of negotiation a suitable PRF is not found, the use of an initial PRF is continued. Which messages and information is actually transmitted between devices during PRF negotiation depends on the implementation.

In an alternative embodiment, the gap time between the end of the received pulse and the start of the next pulse is measured and transmitted to the transmitting device. This can be defined as the time between the point in time at which the output of the integrator is completely flattened out and the point in time at which the sum starts to grow again. Corresponding information is transmitted to the transmitting UWB device for the PRF negotiation or adjustment purpose.

In another alternative embodiment, the CIR over a certain threshold is detected. In this case, the last meaningful multipath component is detected from the integrator output by detecting the corresponding step in the sum. The time between that point in time and the point in time at which the sum starts to grow again is measured. Corresponding information is transmitted to the transmitting UWB device for the PRF negotiation or adjustment purpose.

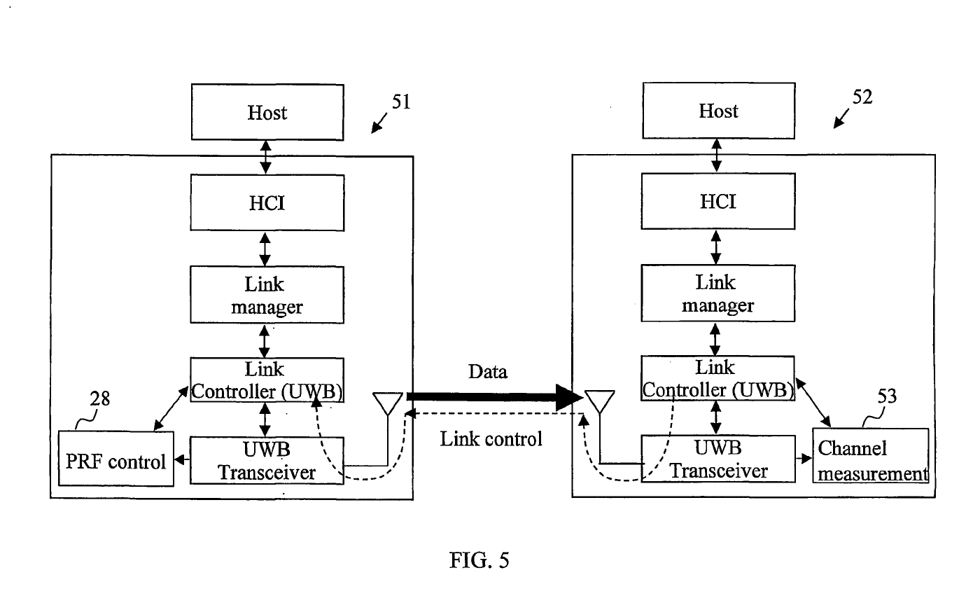

FIG. 5 shows a basic protocol stack structure of two communicating parties 51 and 52. Both communicating parties comprise a UWB radio and corresponding protocol stack. The protocol stack comprises an application layer (Host), an HCI (Host Controller Interface) layer, a link manager layer, a link controller layer and a UWB transceiver layer (physical layer). At the transmitting end 51, downlink user data is conveyed from the application layer (Host) via the HCI, link manager, link controller and physical layer to an air-interface (antenna) for over-the-air transmission. At the receiving end 52, the received signal is conveyed from the air-interface (antenna) via the physical, link controller, link manager and HCI layer to the application layer.

The receiving communication party 52 comprises a channel measurement block for implementing a measurement arrangement, e.g., the measuring arrangement of FIG. 4. Channel measurement information and other link control parameters are sent on link controller level (dashed arrows) from the communication party 52 to the communication party 51.

The transmitting communication party 51 comprises the PRF control block 28 (see also FIG. 2) which is configured to control the used PRF in accordance with the delay spread measurements performed at the receiving end 52. In a practical embodiment, the measured delay spread conditions may be communicated to the transmitting end 51 by adding a suitable parameter to the conventional link control data transmitted in uplink.

Embodiments of the invention give a transmitting device tools with the aid of which the PRF can be appropriately adjusted, based on channel delay measurements, and the air-interface data rate optimized so that the data transmission capasity can be maximized.

It should be noted that, in bidirectional communication, the PRF used for transmission at a first communication device and for reception at a second communication device may be chosen to be different from the PRF used for transmission and reception in the other direction, i.e from the second communication device to the first one.

Particular embodiments of the invention have been described. It is clear to a person skilled in the art that the invention is not restricted to details of the embodiments presented above, but that it can be implemented in other embodiments using equivalent means without deviating from the characteristics of the invention. The scope of the invention is only restricted by the attached patent claims.

1. A method for wideband communication, the method comprising:
transmitting pulses from a first communication device to another device via a wireless link at a pulse repetition frequency, the pulse repetition frequency substantially defining a time difference between adjacent pulses, wherein the method comprises:
performing measurements, based on pulses received at said another device, in order to obtain information on delay conditions of the wireless link; and
adjusting the pulse repetition frequency based on said measurements.

2. The method of claim 1, wherein said measurements comprise measuring how a transmitted pulse is spread in time-domain due to delay on a transmission channel.

3. The method of claim 2, wherein the spread of the transmitted pulse caused by multipath propagation or echoes, experienced at said another device as a delay spread, is measured.

4. The method of claim 1, wherein the method comprises:
transmitting to said first communication device link control information comprising said information on delay conditions for the purpose of adjusting the pulse repetition frequency.

5. The method of claim 1, wherein the method comprises adjustment of the pulse repetition frequency by means of negotiation.

6. The method of claim 1, wherein said first communication device and said another device communicate in accordance with ultra-wideband technology.

7. The method of claim 1, wherein pulses from said first communication device to said another device are transmitted according to impulse radio technology.

8. A communication device configured for wideband communication, the communication device comprising:
a receiver for receiving pulses transmitted, by another device, via a wireless link, wherein the communication device comprises:
a measurement arrangement for measuring, based on the received pulses, delay conditions of the wireless link for link adjustment purpose.

9. The communication device of claim 8, wherein the communication device comprises:
a transmitter for transmitting link control information comprising information indicative of the measured delay conditions to said another device for said link adjustment purpose.

10. The communication device of claim 8, wherein the measurement arrangement is configured for delay spread measurements which indicate how a transmitted pulse is spread in time-domain due to delay on a transmission channel.

11. The communication device of claim 8, wherein the communication device in configured for negotiation of pulse repetition frequency used in pulse transmission.

12. A communication device configured for wideband communication, the communication device comprising:
a transmitter for transmitting pulses via a wireless link to another device; and
a receiver for receiving link control information from said another device, wherein the link control information comprises information indicative of measured delay conditions of the wireless link for link adjustment purpose.

13. The communication device of claim 12, wherein the communication device is configured for transmission of pulses in accordance with a pulse repetition frequency which substantially defines a timedomain transmission interval between two adjacent pulses.

14. The communication device of claim 13, wherein the communication device is configured for adjustment of a pulse repetition frequency of its pulse transmission based on said received information indicative of measured delay conditions of the wireless link.

15. The communication device of claim 12, wherein the measured delay conditions indicate delay spread on a transmission channel.

16. The communication device of claim 12, wherein the transmitter is configured for transmission according to impulse radio technology.

17. The communication device of claim 12, wherein the communication device is configured for operation in accordance with ultra-wideband technology.

18. The communication device of claim 12, wherein the communication device is selected from a group comprising: a mobile phone, a laptop computer, a desktop computer, a Personal Digital Assistant, a digital camera.

19. A system for wideband communication the system comprising a first communication device and a second communication device, wherein the first communication device comprises:
a transmitter for transmitting pulses to said second communication device via a wireless link at a pulse repetition frequency, the pulse repetition frequency substantially defining a time difference between adjacent pulses, wherein the system comprises:
a measurement arrangement for performing measurements, based on pulses received at said another device, in order to obtain information on delay conditions of the wireless link; the system further comprising:
means for adjusting the pulse repetition frequency based on said measurements.

20. The system of claim 19, wherein said measurements comprise channel delay spread measurements for adjustment of pulse repetition frequency used in transmission.
